(19) United States
(12) Patent Application Publication
(10) Pub. No.: US 2023/0123264 A1
(43) Pub. Date: Apr. 20, 2023

(54) SYSTEMS, APPARATUSES AND METHODS FOR PROVIDING A VIRTUAL CARD

(71) Applicant: GTE Financial, Tampa, FL (US)

(72) Inventors: Cindy BRUCATO, Tampa, FL (US); Chad BURNEY, Riverview, FL (US); Stephen MITCHELL, Tampa, FL (US); Kyle DONOVAN, Lutz, FL (US)

(73) Assignee: GTE Financial, Tampa, FL (US)

(21) Appl. No.: 17/502,759

(22) Filed: Oct. 15, 2021

(51) Int. Cl. G06Q 40/02; G06Q 20/34; H04L 29/06

(52) U.S. Cl. CPC G06Q 40/02; G06Q 20/355; H04L 63/08; G06Q 20/3221

(57) ABSTRACT

Provided are systems and methods of issuing an electronic payment card. The method includes receiving, from a terminal device, a request for a new electronic payment card configured to facilitate an electronic payment in an electronic payment system, obtaining a new primary account number (PAN) for the electronic payment card, creating the new electronic payment card and associating the new electronic payment card with the PAN, obtaining a security code corresponding to the PAN for the new electronic payment card, transmitting, to the terminal device, a virtual card corresponding to the new electronic payment card, the virtual card having the PAN and the security code of the new electronic payment card.

### BACKGROUND

### Technical Field

One or more exemplary embodiments relate to systems, apparatuses and methods for providing a static virtual card, and more particularly to systems and methods for facilitating a self-serve card replacement.

### Description of the Related Art

In related art card replacement systems, financial institutions, such as, banks and credit unions offered a virtual card replacement, which required a customer to contact the financial institution to initiate a card creation process. Moreover, the financial institutions that offered a virtual card, only offered a temporary card or “tokenized” card that would either expire after some time and/or the temporary card or tokenized card would not he the exact same as the physical card the customer would receive in the mail. Furthermore, the virtual card received by the customer would not have the same 16 digits, expiration date, and security code (i.e., Card Security Code (CSC) number, Card Verification Value (CVV) number or Card Verification Code (CVC) number) as the physical card. Therefore, the customer would have to repeat the process of updating the card information at all the places the customer had the card on file for quick access when the physical card is received.

That is, the related art card replacement system required the financial institution to initiate or process the card replacement and the temporary or the tokenized card was different from the physical card.

### SUMMARY

Provided are systems, apparatuses and methods for issuing an electronic payment card. For instance, in contrast with the related art systems, the system of the disclosure puts total control in the hands of the consumer, without requiring any assistance or process execution from the financial institution, to reissue themselves a replacement card that is same as the physical card (i.e., 16 digit identification number, expiration date, and/or CVC code), which the customer will receive in the mail. Also during the self-serve process that the consumer performs, the system, according to an aspect of the disclosure, gives the user the ability to automatically provision or add the new replacement card to their electronic wallet, such as Apple Pay or Google Pay® wallet, with a tap on the screen. Again, all of this is at the hands of the user without any assistance from the bank or credit union. Accordingly, the user is able to replace a card on their own end through a self-serve application, without calling the banks or credit unions to receive the replacement card.

According to an aspect of the disclosure, there is provided a method of issuing an electronic payment card including: receiving, from a terminal device, a request for a new electronic payment card configured to facilitate an electronic payment in an electronic payment system, obtaining a new primary account number (PAN) for the electronic payment card, creating the new electronic payment card and associating the new electronic payment card with the PAN, obtaining a security code corresponding to the PAN for the new electronic payment card, and transmitting, to the terminal device, a virtual card corresponding to the new electronic payment card, the virtual card having the PAN and the security code of the new electronic payment card.

The method may further include sending a request to create a physical card including the PAN and the security code.

The new payment card may be one of a credit card or a debit card.

The new payment card may be a replacement card.

The method may further include transmitting a request to an external server to store information corresponding to the new electronic payment card.

The method may further include creating the physical card after the virtual card corresponding to the new electronic payment card is transmitted to the terminal device.

The method may further include requesting the external server to set the new electronic payment card as a virtual card.

According to another aspect of the disclosure, there is provided an apparatus for issuing an electronic payment card including a memory storing one or more instructions; and a processor configured to execute the one or more instructions to: receive, from a terminal device, a request for a new electronic payment card configured to facilitate an electronic payment in an electronic payment system; obtain a new primary account number (PAN) for the electronic payment card; create the new electronic payment card and associate the new electronic payment card with the PAN; obtain a security code corresponding to the PAN for the new electronic payment card; and transmit, to the terminal device, a virtual card corresponding to the new electronic payment card, the virtual card having the PAN and the security code of the new electronic payment card.

The processor may be further configured to send a request to create a physical card including the PAN and the security code.

The processor may be further configured to transmit a request to an external server to store information corresponding to the new electronic payment card.

The processor may be further configured to request the external server to set the new electronic payment card as a virtual card.

### BRIEF DESCRIPTION OF DRAWINGS

FIG. 1 is an overview of a system for issuing a new electronic payment card according to an example embodiment;

FIG. 2A is a block diagram of a terminal device according to an example embodiment;

FIG. 2B is a block diagram of a server according to an example embodiment; and

FIG. 3 is a flowchart illustrating a method for issuing a new electronic payment card according to an example embodiment;

FIG. 4A is an illustration of operations of the method for issuing a new electronic payment card according to an example embodiment;

FIG. 4B is an illustration of operations of the method for issuing a new electronic payment card according to another example embodiment;

FIG. 5A is an illustration of operations of the method for issuing a new electronic payment card according to another example embodiment;

FIG. 5B is an illustration of operations of the method for issuing a new electronic payment card according to another example embodiment; and

FIG. 6 is illustration of an operation of a terminal device according to an example embodiment.

### DETAILED DESCRIPTION OF EXEMPLARY EMBODIMENTS

Example embodiments will now be described below in more detail with reference to the accompanying drawings. The following detailed descriptions are provided to assist the reader in gaining a comprehensive understanding of the methods, apparatuses, and/or systems described herein. However, the example embodiments provided in the disclosure should not be considered as limiting the scope of the disclosure. Accordingly, various changes, modifications, and equivalents of the systems, apparatuses and/or methods described herein will be suggested to those of ordinary skill in the art.

The terms used in the description are intended to describe embodiments only, and shall by no means be restrictive. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

All terms including descriptive or technical terms which are used herein should be construed as having their plain and ordinary meanings. However, the terms may have different meanings according to an intention of one of ordinary skill in the art, precedent cases, or the appearance of new technologies. Also, some terms may be arbitrarily selected by the applicant, and in this case, the meaning of the selected terms will be described in detail in the detailed description. Thus, the terms used herein have to be defined based on the meaning of the terms together with the description throughout the specification.

Also, when a part “includes” or “comprises” an element, unless there is a particular description contrary thereto, the part may further include other elements, not excluding the other elements. In the following description, terms such as “unit” and “module” indicate a unit for processing at least one function or operation, wherein the unit and the block may be embodied as hardware or software or may be embodied by combining hardware and software.

One or more example embodiments of the disclosure will be described below with reference to the drawings. Throughout the drawings, the same components or corresponding components are labeled with the same reference numerals, and, accordingly, the description thereof may be omitted or simplified. However, the one or more exemplary embodiments may be embodied in many different forms, and should not be construed as being limited to the exemplary embodiments set forth herein. Rather, these exemplary embodiments are provided so that this disclosure will be thorough and complete, and will fully convey the concept of the one or more exemplary embodiments to those of ordinary skill in the art. In the following description, well-known functions or constructions are not described in detail since they would obscure the one or more exemplar embodiments with unnecessary detail, and like reference numerals in the drawings denote like or similar elements throughout the specification.

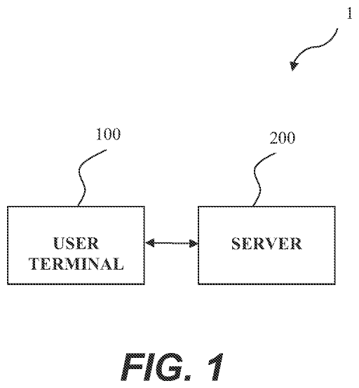

It will be readily understood that the components of the disclosure, as generally described and illustrated in the figures herein, may be arranged and designed in a wide variety of different configurations. Thus, the following more detailed description of the embodiments as represented in FIGS. 1-6, is not intended to limit the scope of the disclosure, as claimed, but is merely representative of selected embodiments of the disclosure.

FIG. 1 is an illustration of a system 1 for issuing a new electronic payment card according to an example embodiment. According to an example embodiment, the system 1 facilitates the provision of a replacement card in the hands of a user. The user may be a customer of a service provider of the electronic card. According to an example embodiment, the system 1 facilitates the provision of the replacement card in the hands of a customer in a very short period of time, i.e., within seconds, instead of the customer having to wait for the standard 5 to 7 business days before getting their new card. According to an example embodiment, the system 1 allows the customer to log into an application (i.e., a mobile app) and instantly obtain a replacement card at their leisure. Also, the application will allow the customer to add the new card into their electronic wallet, thereby allowing the customer or the user to continue making card-not-present purchases before receiving and activating the physical card. According to an example embodiment, the card-not-present purchases are purchases allowed using the virtual replacement card before physical card is issued and/or activated. Here, the card-not-present purchases refers to physical card not being physical available to the user and not activated by the user. According to an example embodiment, after the physical card is received and activated, the customer or the user may be allowed to may card-present purchases.

For instance, in a related art system, customers had to contact their financial institution to initiate the process of getting a new replacement card, requiring the financial institution's staff to work the request, and execute the process to generate a new replacement debit/credit card. The system 1 of the disclosure provides a practical application that addresses this problem and/or other problems by giving total control of the process of obtaining a new replacement card, such a debit card or a credit card in the hands of the customer. Thus, the customer is able to receive and use a new card within seconds, rather than having to wait the standard 5 to 7 business days before they can access their account/funds. That is, with the self-service system 1, customers can continue accessing their money or credit, to make card not present, within seconds without the user having to call or contact the bank or the credit union.

According to an example embodiment, after the physical card is received and activated, card present purchases may be made. That is, the card present purchase requires receiving and activating physical card or receiving an activated physical card. For instance, the physical card may be received either via mail and calling to activate or by picking up an “instant issue” card from a community financial center that is already activated.

According to an example embodiment, the system 1 includes a user terminal 100 and a server 200. However, the disclosure is not limited thereto, and other components may be added to the system to facilitate the issuance of a new card according to another example embodiment of the disclosure.

According to the example embodiment, the user terminal 100 may be a mobile phone, a smart phone, a desktop personal computer (PC), a laptop PC, a tablet PC, a portable electronic device or the like. According to an example embodiment, the server 200 may include a plurality of servers, virtual servers, or other configurations.

According to an example embodiment, the terminal device 100 may receive a request for a new electronic payment card configured to facilitate an electronic payment in an electronic payment system. The request for the new electronic payment card may be a request to replace a stolen or a lost electronic payment card. According to an embodiment, the new electronic payment card is one of a credit card or a debit card.

According to an example embodiment, the user may launch an application on the terminal device 100 corresponding to an electronic payment card. For example, the user may be a customer or a member, who has an account registered in the application. Moreover, the user may have one or more electronic payment cards registered under the account. Accordingly, in a case in which an electronic payment card is lost or stolen, the user may request a replacement card.

According to an example embodiment, the server 200 may receive, from the terminal device 100, the request for the new electronic payment card configured to facilitate an electronic payment in an electronic payment system. The request for the new electronic payment card may be a request to replace a stolen or a lost electronic payment card. According to an embodiment, the new electronic payment card is one of a credit card or a debit card.

According to an example embodiment, the server 200 may obtain a new primary account number (PAN) for the new electronic payment card. According to an example embodiment, the server 200 may contact or communicate with an external server of a financial institution to obtain the new PAN for the new electronic payment card. However, the disclosure is not limited thereto, and the PAN may be obtained in a different manner.

According to an example embodiment, the server 200 may create the new electronic payment card based on the new PAN. According to an example embodiment, the server may associate the new electronic payment card with the new PAN. Moreover, the server 200 may obtain a security code corresponding to the PAN for the new electronic payment card.

According to an example embodiment, the server 200 may contact or communicate with an application server to obtain the security code for the new electronic payment card. However, the disclosure is not limited thereto, and the security code may be obtained in a different manner. For instance, the server 200 may obtain the security code through an API (Application Programming Interface) or Card Wizard Application. For instance, the system may use a card wizard API to generate or retrieve the CVC. According to an example embodiment, the security code may be a CSC number, CCV number or CVC number, but the disclosure is not limited thereto.

Accordingly to an example embodiment, the server 200 may transmit, to the terminal device 100, a virtual card corresponding to the new electronic payment card, the virtual card having the PAN and the security code of the new electronic payment card. According to an example embodiment, the PAN and the security code of the new electronic payment card is same as a physical card created in response to the request for the new electronic payment card.

According to an example embodiment, the server 200 may further send a request to create a physical card including the PAN and the security code. According to an example embodiment, the server 200 may further send a request to an external server to store information corresponding to the new electronic payment card. According to an example embodiment, the server 200 may further request the external server to set the new electronic payment card as a virtual card.

According to an example embodiment, after the new electronic payment card is transmitted to the terminal device 100, the user of the terminal device 100 may automatically provision the new replacement card to their electronic wallet such as Apple Pay® or Google Pay® wallet with a tap of the screen. For example, the user of the terminal device 100 may select the new electronic payment card and register or update the card information in the electronic wallet.

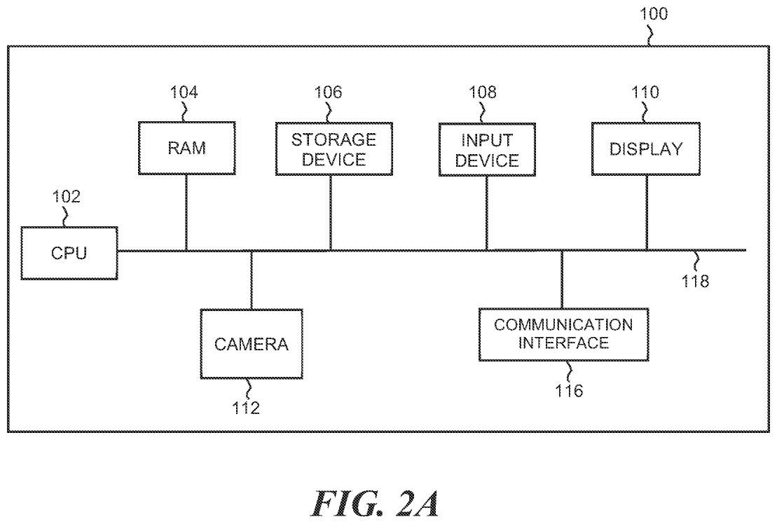

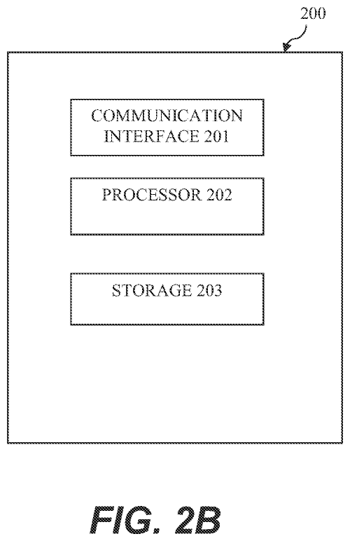

FIG. 2A is a block diagram of the terminal device 100 according to an example embodiment. According to an example embodiment, the terminal device 100 has a CPU 102, a RAM 104, a storage device 106, an input device 108, a display 110, a camera 112, and a communication interface 116. The CPU 102, the RAM 104, the storage device 106, the input device 108, the display 110, the camera 112, and the communication unit 116 may be connected to a bus line 118. However, the disclosure is not limited thereto, and as such a different configuration of components may be included in the terminal device.

The CPU 102 may function as a control unit that operates by executing a program stored in the storage device 106 and controls the operation of the terminal device 100. Further, the CPU 102 may execute an application program stored in the storage device 106 to perform various processes as the terminal device 100. The RAM 104 may provide a memory field necessary for the operation of the CPU 102.

The storage device 106 may be formed of a storage medium such as a non-volatile memory, a hard disk drive, or the like and functions as a storage unit. The storage device 106 may store a program executed by the CPU 102, data referenced by the CPU 102 when the program is executed, or the like.

The input device 108 may be a touchscreen embedded in the display 110, for example. The input device 108 may function as an input unit that accepts input from a user. According to another example embodiment, the input device 108 may be implemented through speech recognition, keyboard, mouse or other types of input.

The display 110 may function as a display unit that displays various windows or screens to a user using the terminal device 100. For example, the display 110 may display information related to an application electronic payment cards. For instance, the display 110 may display selectable options for the user to perform functions related to the electronic payment card. The display device 110 is a liquid crystal display, an organic light emitting diode (OLED) display, or the like and is used for displaying a moving image, a static image, a text, or the like. The input device 108 is a button, a touchscreen, a keyboard, a pointing device, or the like and is used by a user to operate the terminal device 100. The display device 110 and the input device 108 may be integrally formed as a touchscreen.

The camera 112 may capture an image. For example, the camera 112 may be a digital camera. According to an example embodiment, the digital camera may use a Complementary Metal Oxide Semiconductor (CMOS) image sensor, a Charge Coupled Device (CCD) image sensor, or the like.

According to an embodiment, the communication unit 116 may be connected to a network and may transmit and receive data via the network. The communication unit 116 communicate with the server 200 or the like under the control of the CPU 102. The communication interface 116 is a communication interface based on a specification such as Wi-Fi® (registered trademark), 4G, 5G, or the like, which is a module for communicating with other devices. The communication interface may also be implemented using a Near Field Communications technology.

While respective components forming the terminal device are illustrated in FIG. 2A as an integrated device, some of the components and/or some of the functions performed by the components thereof may be by an externally attached device. For example, the display device 110, the input device 108, and the camera 112 may be externally attached devices that are separate from a part performing the function of a computer including the CPU 102 or the like.

According to another example embodiment, the CPU 102 may be replaced with a processor, i.e., a hardware processor. According to another example embodiment, the processor may be implemented by a combination of hardware and software components. According to another example embodiment, the processor may be implemented by a configuration of electronic components including one or more circuitry components.

For instance, the processor has a function of performing an operation in accordance with a program stored in the RAM (random access memory), ROM (read only memory), the HDD (hard disk drive), or the like and controlling each component of the terminal device 100. According to an example embodiment, the processor may obtain one or more instructions stored in the ROM, the or the like and execute the one or more instructions to perform one or more operations. The one or more operations may include controlling one or more components of the information processing system 10 to perform one or more operations.

According to an example embodiment, the RAM is formed of a volatile storage medium and provides a temporary memory field required for the operation of the processor. The ROM is formed of a nonvolatile storage medium and stores necessary information such as a program used in the operation of the terminal device 100. The HDD is a storage device that is formed of a nonvolatile storage medium and stores an image captured by the camera 112 or the like.

According to an example embodiment, the hardware configuration illustrated in FIG. 2A is an example, and a device other than the devices thereof may be added, or some of the devices may not be provided. Further, some of the devices may be replaced with another device having a similar function. Furthermore, some of the functions may be provided by another device via a network, or the functions forming the example embodiment may be implemented by being distributed in a plurality of devices. For example, the HDD may be replaced with a solid state drive (SSD) using a semiconductor element such as a flash memory or may be replaced with cloud storage.

FIG. 2B is a block diagram of the server 200 according to an example embodiment. According to an example embodiment, the server 200 has a communication interface 201, a processor 202, and a storage 203. According to an example embodiment, the processor may be a CPU or other processing circuit. According to an example embodiment, the storage 203 may include a RAM, a ROM, an HDD or the like.

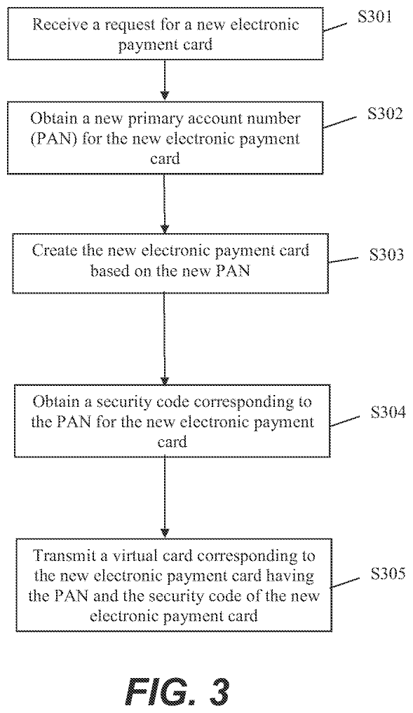

FIG. 3 is flowchart illustrating operations of a method of issuing an electronic payment card. According to an example embodiment, the operations illustrated in FIG. 3 may be performed by a server configured to communicate with a terminal device.

Referring to FIG. 3, in operation S301, the server may receive, from a terminal device, a request for a new electronic payment card configured to facilitate an electronic payment in an electronic payment system. The request for the new electronic payment card may be a request to replace a stolen or a lost electronic payment card. According to an embodiment, the new electronic payment card is one of a credit card or a debit card.

In operation S302, the server may obtain a new primary account number (PAN) for the new electronic payment card. According to an example embodiment, the server may contact or communicate with an external device or an external server to obtain the new PAN for the new electronic payment card. According to an example embodiment, the external server may be a server of a financial institution. However, the disclosure is not limited thereto, and the PAN may be obtained in a different manner.

In operation S303, the server may create the new electronic payment card based on the new PAN. According to an example embodiment, the server may associate the new electronic payment card with the new PAN.

In operation S304, the server may obtain a security code corresponding to the PAN for the new electronic payment card. According to an example embodiment, the server may contact or communicate with an external device or an external server to obtain the security code for the new electronic payment card. According to an example embodiment, this external device or external server may be a security server. However, the disclosure is not limited thereto, and the security code may be obtained in a different manner. According to an example embodiment, the security code may be a CSC number, CVV number or CVC number, but the disclosure is not limited thereto.

In operation S305, the server may transmit, to the terminal device, a virtual card corresponding to the new electronic payment card, the virtual card having the PAN and the security code of the new electronic payment card. According to an example embodiment, the PAN and the security code of the new electronic payment card is same as a physical card created in response to the request for the new electronic payment card.

According to an example embodiment, the server may further send a request to create a physical card including the PAN and the security code.

According to an example embodiment, the server may further send a request to an external server to store information corresponding to the new electronic payment card. According to an example embodiment, the server may further request the external server to set the new electronic payment card as a virtual card.

According to an example embodiment, after the new electronic payment card is transmitted to the terminal device, the user of the terminal device may automatically provision or add the new replacement card to their electronic wallet, such as Apple Pay®, Google Pay® or Samsung Pay®, with a tap of the screen.

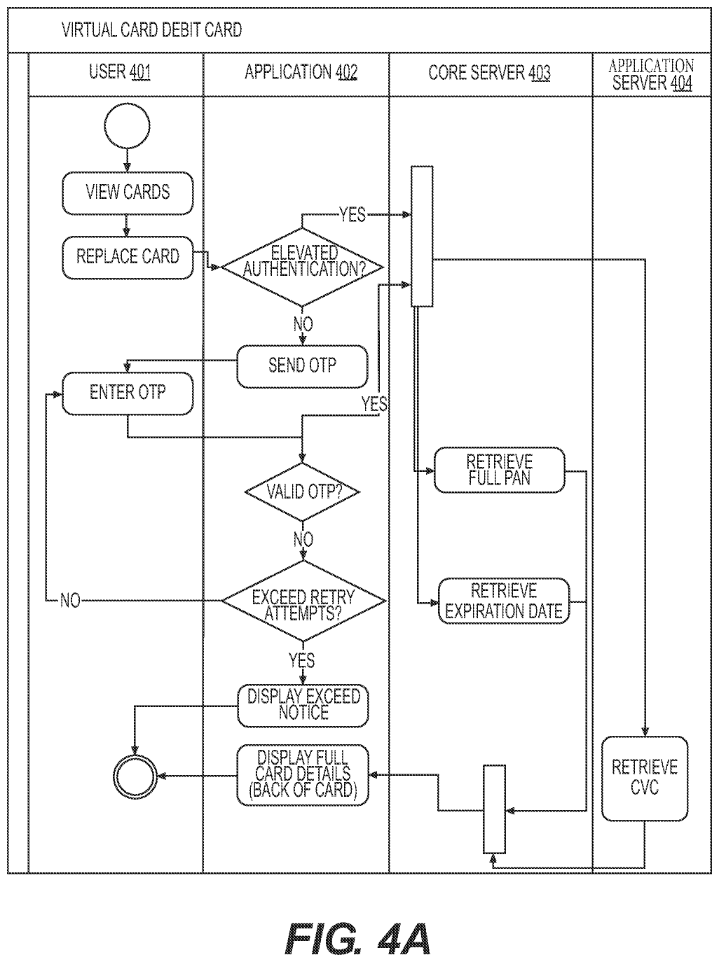

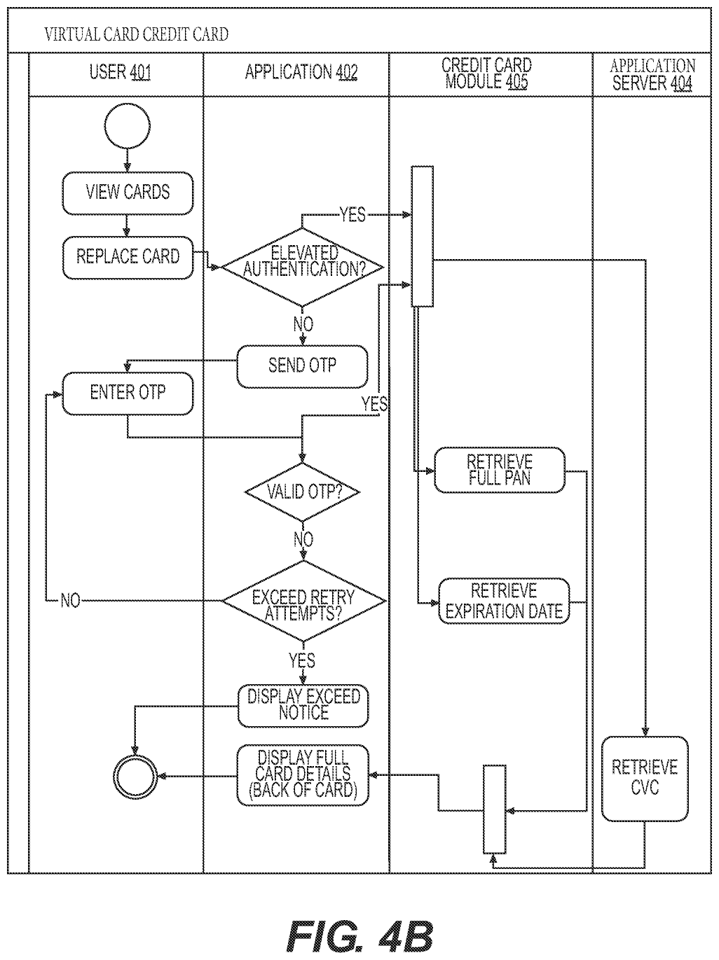

FIGS. 4A and 4B illustrate operations of the method for issuing a new electronic payment card according to an example embodiment.

Referring to FIG. 4A, according to an example embodiment, a user 401 may launch an application 402 on the terminal device 100. According to an example embodiment, the application may be a mobile app installed on a smart phone. The user 401 may view electronic payment cards managed in the application 402. According to an example embodiment, the user 401 may request a new electronic payment card. The request for the new electronic payment card may be a request to replace a stolen or a lost electronic payment card. According to an embodiment, the new electronic payment card is one of a credit card or a debit card.

In response to receiving a request to replace the electronic payment card, the application 402 may perform an authentication process. According to an example embodiment, the authentication may be an elevated authentication process. Based on a determination that the authentication is successful, the application 402 may transmit the request to replace the electronic payment card to a core server 403.

According to an example embodiment, the core server 403 may obtain a new primary account number (PAN) for the new electronic payment card. According to an example embodiment, the server may contact or communicate with an external server, i.e., as a server of a financial institution, to obtain the new PAN for the new electronic payment card. However, the disclosure is not limited thereto, and the PAN may be obtained in a different manner, by communicating with another external device.

According to an example embodiment, the core server 403 may further obtain an expiration date for the new electronic payment card. According to an example embodiment, the core server 403 may create the new electronic payment card based on the new PAN and the expiration date. According to an example embodiment, the core server 403 may associate the new electronic payment card with the new PAN and the expiration date.

Moreover, the core server 403 may obtain a security code corresponding to the PAN for the new electronic payment card. According to an example embodiment, the core server 403 may contact or communicate with a application server 404 or a card server to obtain the security code for the new electronic payment card. However, the disclosure is not limited thereto, and the security code may be obtained in a different manner. According to an example embodiment, the security code may be a CSC number, CVV number or CVC number, but the disclosure is not limited thereto.

According to an example embodiment, the core server 403 may transmit, to the application 402, a virtual card corresponding to the new electronic payment card, the virtual card having the PAN, the expiration date and the security code of the new electronic payment card. According to an example embodiment, the PAN, the expiration date and the security code of the new electronic payment card is same as a physical card created in response to the request for the new electronic payment card.

According to an example embodiment, when a user is logged into the card application, and requests a replacement card, the system issues a OTP (one-time password) as a step-up authentication for the card replacement process or for presentation of the virtual card information as an additional measure to improve security. For example, the application 402 may send an OTP to the user 401, and request the user to enter the OTP. If the OTP entered by the user matches the OTP sent to the user (i.e., OTP is successful), the application 402 may transmit the request to replace the electronic payment card to the core server 403, and the core server 403 may obtain the new PAN, the expiration date and the security code as described above. Moreover, the core server 403 may transmit, to the application 402, a virtual card corresponding to the new electronic payment card, the virtual card having the PAN, the expiration date and the security code of the new electronic payment card.

According to an example embodiment, if the OTP entered by the user does not match the OTP sent to the user (i.e., OTP is unsuccessful), application 402 may rescind another OTP to the user 401 to retry. However, if the number of retry attempts exceed a specific number, the application 402 may display a notification that the user 401 has exceeded the limit. Here, the application 402 stops the request for replacement card.

According to an example embodiment, the application 402 receives the virtual card corresponding to the new electronic payment card and displays the virtual card. Here, the virtual card has the PAN, the expiration date and the security code of the new electronic payment card. According to an example embodiment, the user 401 may automatically provision the new replacement card to their electronic wallet such as Apple Pay® or Google Pay® wallet with a tap of the screen. For example, the user 401 of the terminal device 100 may select the new electronic payment card and register or update the card information in the electronic wallet.

Referring to FIG. 4B, the operations of the method for issuing a new electronic payment card are similar to the operations illustrated in FIG. 4A, except the core server 403 is replaced with a credit card module 405. According to an example embodiment, the credit card module 405 may be an application or program running on a device of a card service provider.

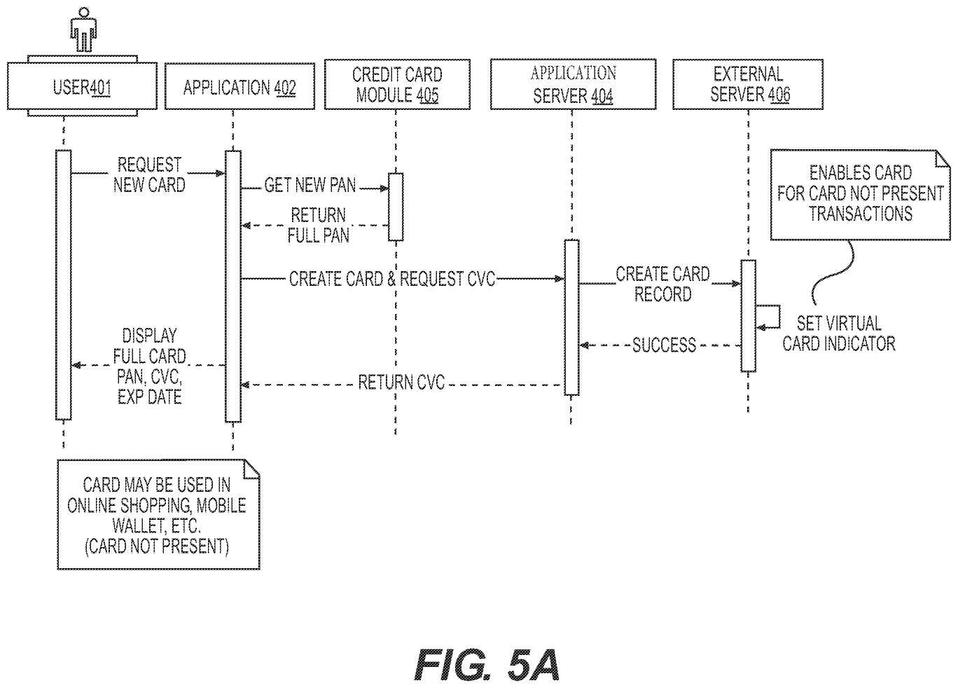

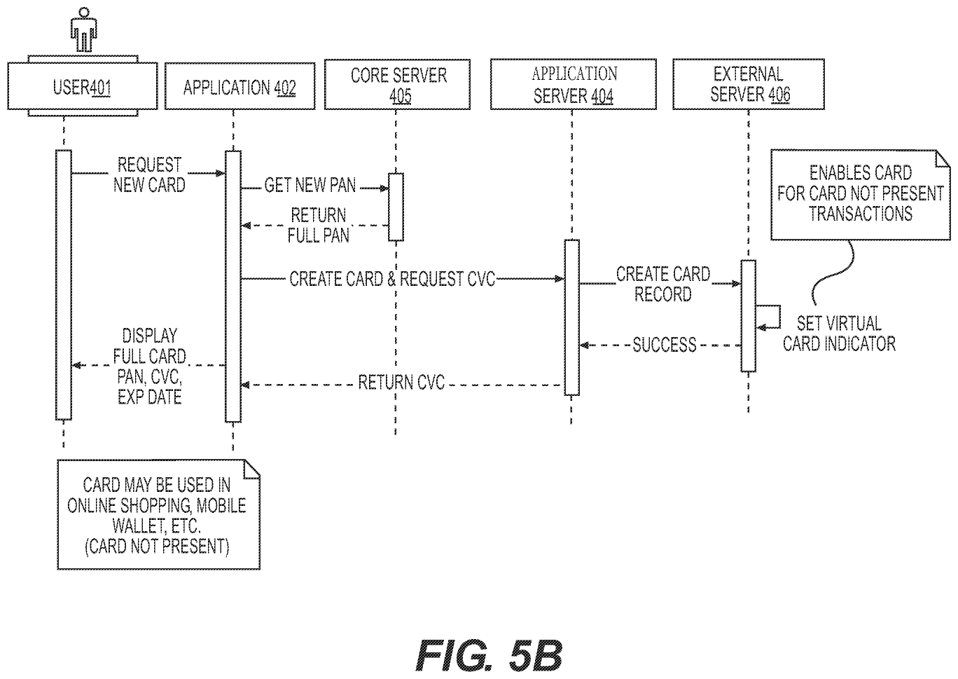

FIGS. 5A and 5B illustrate operations of the method for issuing a new electronic payment card according to another example embodiment.

Referring to FIG. 5A, the operations of the method for issuing a new electronic payment card are similar to the operations illustrated in FIG. 4A, except an external server 406 is further provided. For instance, according to an example embodiment illustrated in FIG. 5A, the application server 404 may transmit a request to an external server 406 to record the new electronic payment card. According to an example embodiment, the external server 406 may set the new electronic payment card as a virtual card, which is authorized for transactions without a physical card. According to an example embodiment, the external server 406 may be a server of a financial institution, such as a bank or a credit union.

Referring to FIG. 5B, the operations of the method for issuing a new electronic payment card are similar to the operations illustrated in FIG. 4B, except an external server 406 is further provided. For instance, according to an example embodiment illustrated in FIG. 5B, the application server 404 may transmit a request to an external server 406 to record the new electronic payment card.

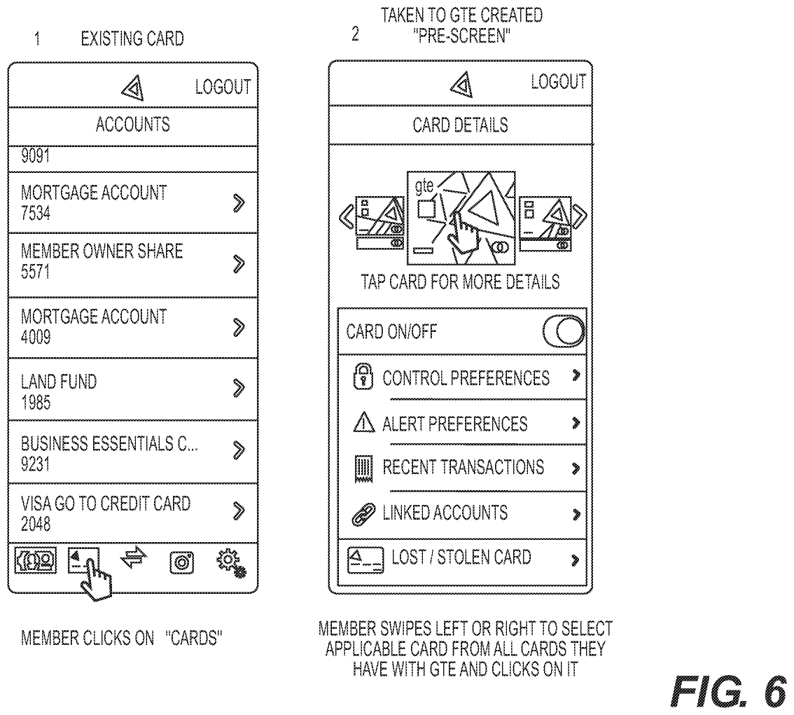

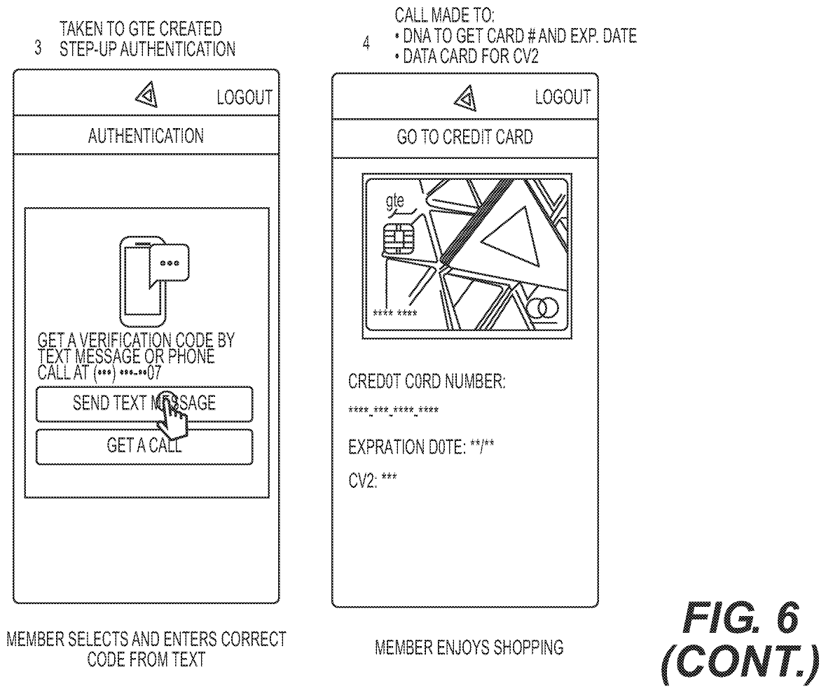

FIG. 6 is an illustration of an application for managing electronic payment cards on a terminal device according to an example embodiment.

According to an example embodiment, a user may click on a cards tab of an application for managing electronic payment cards on a terminal device. In response, the application may display one or more existing electronic payment cards of the user being managed by the application.

According to an example embodiment, the user may select a card from the one or more existing electronic payment cards. According to an example embodiment, the user may swipe left or right to view the different cards and select a card for replacement.

According to an example embodiment, an authentication process is performed to authenticate a user. According to an example embodiment, the authentication may be performed through a OTP. Upon successful authentication, the application may transmit a request to replace the selected card to a server. Therefore, the application may receive the virtual card corresponding to the new electronic payment card and display the virtual card. Here, the virtual card has the PAN, the expiration date and the security code of the new electronic payment card. According to an example embodiment, the application nay automatically provision the new replacement card to their electronic wallet such as Apple Pay® or Google Pay® wallet with a tap of the screen. For example, the user of the terminal device 100 may select the new electronic payment card and register or update the card information in the electronic wallet. According to an example embodiment, the user of the terminal device 100 is able to make transactions using the newly issued replacement electronic payment card immediately.

A detailed explanation of an application for managing electronic payment cards on a terminal device is provided below with respect to FIG. 6, according to an example embodiment.

According to an example embodiment, a user may select and launch an application on a user device. According to an example embodiment, the application may be a card application for managing one or more electronic payment cards. According to an example embodiment, the user device may be a smart phone, tablet, a laptop, a computer, an electronic watch, or an electronic device capable running the card application. According to an example embodiment, the card application nay be a mobile app on a smart phone, a tablet or a watch.

In response to launching the application, the user may be required to authenticate the user's identity prior to access of information related to the one or more electronic payment cards. For instance, the card application may display an input field for receiving a user ID and a password. According to another example embodiment, the card application may provide an interface to receive biometric data, such as a face ID, to perform user identification and authentication. According to an example embodiment, multiple levels of authentication (multi-factor authentication) may be performed. For instance, the multi-factor authentication may include OTP sent to a user's phone number, or an email address. However, the authentication method is not limited to the examples provided herein.

According to an example embodiment, when the user authentication is not successful, the user may not be granted access to the one or more electronic payment cards associated with the user. In this case, the user may have to perform additional operations to verify their identity or contact customer service to resolve the issue.

According to an example embodiment, when the user authentication is successful, the user may be granted access to the one or more electronic payment cards associated with the user. According to an example embodiment, the card application may provide an account level presentation of the one or more electronic cards associated with the user.

According to an example embodiment, the card application may display one or more accounts associated with the user. For example, instead of displaying all the cards associated with the user at one time, the card application may display different accounts associated with the user. Thereafter, when the user selects an account, one or more electronic cards associated with the account for the user may be displayed. According to an example embodiment, the user may register or enroll one or more electronic cards to an account, among a plurality of accounts, for more conveniently managing the electronic cards.

According to an example embodiment, when the user selects an account, the card application uses Debit Network Alliance (DNA) API (Application Programming Interface) and/or Credit Card Management (CCM) API to communicate with one or more servers to get only electronic cards associated with the account the member has selected. According to an example embodiment, the card application may receive information about the electronic cards associated with the selected account of the user. After receiving information related to the electronic cards associated with the account, the card application may display the information related to the electronic cards for the selected account. In this manner, the card application, according to an example embedment, improves the user's experience by providing convenient access for users and members managing electronic cards across multiple accounts.

According to an example embodiment, the card application may display the information in a card carousal or a card list under the selected account tab. However, the disclosure is not limited to the electronic card presentation described herewith, and as such, according to another example embodiment, the electronic cards may be displayed in a different manner.

According to an example embodiment, once presented with the card carousel, the user may swipe through the electronic cards to select one of the electronic cards and/or select one of the additional options for self-service. For instance, the additional options may include an option for turning electronic card purchases on or off for the selected card or the selected account, an option to flip the electronic cards to see the full PAN, Expiration Date, and CVC code, and an option to replace card. However, the disclosure is not limited thereto, and as such, according to another example embodiment, other options may be provided to facilitate an easy and convenient electronic card management for the user.

According to an example embodiment, the electronic card purchases on or off function may be performed using a card valet API, which may require the user and/or the electronic card to be first enrolled with a card server and then push an on/off status for card purchases as selected by the user to the card server. According to an example embodiment, the card valet API may also validate the user with a get call function and enroll the user and the electronic card using a push command.

According to an example embodiment, a user may select to manage their card with additional options, which may provide advanced controls related to the electronic card. According to an example embodiment, the user may select to receive push alerts corresponding to the managed electronic cards from one or more services or applications related to the electronic cards by performing a single sign on (SSG) operation into one or more services or applications related to the electronic cards.

According to an example embodiment, the user may select a flip card option to see the full PAN, Expiration Date, and CVC code. According to an example embodiment, when the user selects the flip card option, the card application may display the full PAN, Expiration Date, and CVC code on the display screen. According to an example embodiment, since the flip feature has additional risk of credit card exposure, the card application may prompt the user to perform a step up authentication in the form of a onetime passcode sent to their phone number on file or email address before displaying the full PAN, Expiration Date, and CVC code.

According to an example embodiment, the user must enter the one time passcode within a certain period of time. For instance, the user must enter the one time passcode within 5 minutes. However, the disclosure is not limited thereto, and the user may enter the passcode within another predetermined time. After the passcode is verified, the card PAN, expiration and CVC are presented to the user.

According to an example embodiment, a first message may be sent corresponding to the one time passcode notifying the user to not share the passcode. According to an example embodiment, the notification message may be sent along with the one time passcode. According to an example embodiment, the notification message may be a warning message informing the user to not share the passcode with anyone asking for the passcode via a phone call. According to an example embodiment, a second message may be sent corresponding to the one time passcode reminding the user to not share the passcode.

According to an example embodiment, the card application may use a DNA (Debit) API and/or a CCM (Credit) API to get the PAN and Expiration, and then use these values and a Data Card API to calculate the matching CVC. Unlike related art applications, which present tokenized card data, the card application according to an example embodiment presents the actual card data. As such, when the card is entered into a merchant payment system (i.e., e-commerce websites), the information such as the PAN, Expiration date and CVC do not need to change when the physical card arrives in case of a replacement card being issued.

For instance, according to an example embodiment, the user is able to replace their card instantly within the card application and create a virtual card, which has the same card data as the physical card to be issued as the replacement. According to an example embodiment, the user may select a reason (i.e., lost, stolen, fraud, damaged) for the replacement card. Also, the user may indicate the method of delivery for the physical card, (i.e., standard or expedited delivery or pick up at a local service center).

According to an example embodiment, once a card replacement request is received by the card application, the card application may use the DNA (Debit) API or the CCM (Credit) API to change the status of the electronic card to close the electronic card. Moreover, according to an example embodiment, the card application may use the DNA (Debit) API or the CCM (Credit) API to create a new card. According to an example embodiment, the card application may receive a new PAN and Expiration Date, and create a new card using a Card Services API.

According to an example embodiment, regardless of the delivery or pickup method, all physical cards can be used immediately as a virtual card. Moreover, by flipping the card and getting the PAN, Expiration, and CVC within the card application, the card may be flagged as a virtual card using the Card Services API and is allowed to perform physical card not present transactions, even if the physical card has not arrived and the physical card is not activated by the user. For instance, when the new card is issued, and when the physical card is not yet activated, a flag may be set at an external server, which indicates that the virtual card is active to perform transactions even though the physical card is not present or activated. The flag may be a card-not-present flag. Moreover, according to an example embodiment, after the physical card is received by the user, and the physical card is activated by the user, a flag may be set at the external server, which indicates that the physical card is active to make card present purchases. According to an example embodiment, the external server may reset the card-not-present flag.

According to an example embodiment, the electronic card, including virtual cards can be added to electronic card wallets, such as Apple Pay®, Samsung Pay®, or Google Pay® immediately. According to an example embodiment, once a virtual card is created and the virtual card is issued, and the user is logged into the card application, the card application may determine if one or more of the electronic card wallets is available and present an option to the user to add the virtual card to one or more of the electronic card wallets. According to an example embodiment, the card application may automatically present the option or prompt the user to add the virtual card to one or more of the electronic card wallets. According to an example embodiment, based on the user's selection to add the virtual card to one or more of the electronic card wallets, the card application may use a Card Services API, and push the card to the selected electronic card wallet using an Integrated Data Infrastructure (IDI) API. According to an example embodiment, once the card is added to the electronic card wallet, the card application indicates that the card is added to wallet or that the card is added to wallet.

The disclosure is not limited to the example embodiments described above but can be changed as appropriate within a range not departing from the spirit of the disclosure. For example, although one or more example embodiments illustrate a process related to replacement of a lost or stolen card, the disclosure is not limited thereto. As such, according to another example embodiment, the process described in FIGS. 1-6 above may be implemented when a user or a customer requests a brand new card (i.e., not a replacement card).

According to an example embodiment, the system 1 facilitates a provision of a brand new card in the hands of a user in a very short period of time, i.e., within seconds, instead of the customer having to wait for the standard 5 to 7 business days before getting their brand new card. Also, the application will allow the customer to add the brand new card into their electronic wallet, thereby allowing the customer or the user to make card-not-present purchases before receiving and activating the physical card.

The scope of one or more example embodiments also includes a processing method of storing, in a storage medium, a program that causes the configuration of the example embodiment to operate to implement the function of the example embodiment described above, reading out as a code the program stored in the storage medium, and executing the code in a computer. That is, a computer readable storage medium is also included in the scope of each example embodiment. Further, not only the storage medium in which the program described above is stored but also the program itself is included in each example embodiment. Further, one or more components included in the example embodiments described above may be a circuit such as Application Specific Integrated Circuit (ASIC), a Field Programmable Gate Array (FPGA), or the like configured to implement the function of each component.

As the storage medium, for example, a floppy (registered trademark) disk, a hard disk, an optical disk, a magneto-optical disk, a Compact Disk (CD)-ROM, a magnetic tape, a nonvolatile memory card, or a ROM can be used. Further, the scope of each of the example embodiments includes an example that operates on Operating System (OS) to perform a process in cooperation with another software or a function of an add-in board without being limited to an example that performs a process by an individual program stored in the storage medium.

The service implemented by the function of one or more example embodiments described above can be provided to the user in a form of Software as a Service (SaaS).

Note that all the example embodiments described above are mere examples of embodiments in implementing the disclosure, and the technical scope of the disclosure should not be construed in a limiting sense by these example embodiments. That is, the disclosure can be implemented in various forms without departing from the technical concept thereof or the primary feature thereof.

One or more exemplary embodiments may also be embodied as programmed commands to be executed in various computer means, and then may be recorded to a computer-readable storage medium. The computer-readable storage medium may include one or more of the programmed commands, data files, data structures, or the like. The programmed commands recorded to the computer-readable storage medium may be particularly designed or configured for one or more exemplary embodiments. Examples of the computer-readable storage medium include magnetic media including hard disks, magnetic tapes, and floppy disks, optical media including CD-ROMs and DVDs, magneto-optical media including optical disks, and a hardware apparatus designed to store and execute the programmed commands in ROM, RAM, a flash memory, and the like. The hardware apparatus may be configured to function as one or more software modules so as to perform operations of one or more exemplary embodiments.

It should be understood that the exemplary embodiments described herein should be considered in a descriptive sense only and not for purposes of limitation. Descriptions of features or aspects within each embodiment should typically be considered as available for other similar features or aspects in other embodiments.

While one or more exemplary embodiments have been described with reference to the figures, it will be understood by those of ordinary skill in the art that various changes in form and details may be made therein without departing from the spirit and scope of the inventive concept as defined by the following claims.

1. A method of issuing an electronic payment card comprising:
receiving, from a terminal device, a request for a new electronic payment card configured to facilitate an electronic payment in an electronic payment system;
obtaining a new primary account number (PAN) for the electronic payment card;
creating the new electronic payment card and associating the new electronic payment card with the PAN;
obtaining a security code corresponding to the PAN for the new electronic payment card; and
transmitting, to the terminal device, a virtual card corresponding to the new electronic payment card, the virtual card having the PAN and the security code of the new electronic payment card.

2. The method of claim 1, further comprising:
sending a request to create a physical card including the PAN and the security code.

3. The method of claim 1, wherein the new electronic payment card is one of a credit card or a debit card.

4. The method of claim 1, wherein the new payment card is a replacement card.

5. The method of claim 1, further comprising:
transmitting a request to an external server to store information corresponding to the new electronic payment card.

6. The method of claim 1, further comprising:
creating the physical card after the virtual card corresponding to the new electronic payment card is transmitted to the terminal device.

7. The method of claim 1, further comprising:
requesting the external server to set the new electronic payment card as a virtual card.

8. An apparatus for issuing an electronic payment card, the apparatus comprising:
a memory storing one or more instructions; and
a processor configured to execute the one or more instructions to:
receive, from a terminal device, a request for a new electronic payment card configured to facilitate an electronic payment in an electronic payment system;
obtain a new primary account number (PAN) for the electronic payment card;
create the new electronic payment card and associate the new electronic payment card with the PAN;
obtain a security code corresponding to the PAN for the new electronic payment card; and
transmit, to the terminal device, a virtual card corresponding to the new electronic payment card, the virtual card having the PAN and the security code of the new electronic payment card.

9. The apparatus of claim 8, wherein the processor is further configured to:
send a request to create a physical card including the PAN and the security code.

10. The apparatus of claim 8, wherein the new electronic payment card is one of a credit card or a debit card.

11. The apparatus of claim 8, wherein the new payment card is a replacement card.

12. The apparatus of claim 8, wherein the processor is further configured to:
transmit a request to an external server to store information corresponding to the new electronic payment card.

13. The apparatus of claim 8, wherein the physical card is created after the virtual card corresponding to the new electronic payment card is transmitted to the terminal device.

14. The apparatus of claim 11, wherein the processor is further configured to:
request the external server to set the new electronic payment card as a virtual card.

15. A terminal device for managing electronic payment cards comprising:
a memory storing one or more instructions; and
a processor configured to execute the one or more instructions to:
display one or more existing electronic payment cards associated with an account of a user;
receive a selection of a card, among the one or more existing electronic payment cards, from the user for replacement;
perform an authentication process to authenticate the user;
based on a result of a successful authentication, transmit a request to replace the card selected by the user; and
receive a virtual card corresponding to a new electronic payment card, the virtual card having a primary account number (PAN), an expiration date and a security code of the new electronic payment card, which is same as a physical card.
